(19) United States
(12) Patent Application Publication
(10) Pub. No.: US 2003/0147261 A1
(43) Pub. Date: Aug. 7, 2003

(54) Liquid light guide system for interior lighting

(76) Inventors: Victor Babbitt, Berthoud, CO (US); Neil L. McClure, Longmont, CO (US)

Correspondence Address: LATHROP & GAGE LC, 4845 PEARL EAST CIRCLE, SUITE 300, BOULDER, CO, 80301, US

(21) Appl. No.: 10/334,640

(22) Filed: Dec. 31, 2002

Related U.S. Application Data
(60) Provisional application No. 60/345,268, filed on Jan. 3, 2002.

(51) Int. Cl. G02B 6/24; F21V 9/12

(52) U.S. Cl. 362/582; 362/583; 362/580; 362/318

(57) ABSTRACT

A liquid-filled light guide is coupled with a solar collector and a light dispersion device to form a system used to illuminate the interior of a human-inhabitable structure, such as building, underground space or lightless underwater space. The liquid filled light guide establishes a light transmissive pathway that may be split and joined through the use of liquid filled coupling devices.

### RELATED APPLICATIONS

This application claims benefit of priority to provisional application serial No. 60/345,268 filed Jan. 3, 2002.

### BACKGROUND OF THE INVENTION

1. Field Of The Invention

The present invention relates generally to light guides and lighting systems for the transferring of illuminating light, such as solar light, to interior environments, and more particularly, to liquid filled light guides and coupling systems to allow the collection, transmission and distribution of this light.

2. Discussion of the Related Art

The rising cost of electrical power, the environmental and other problems associated with electrical power, and the benefits of sunlight as opposed to artificial light result in the need to illuminate interior environments with sunlight. In many states, direct sunlight is available 2000 to 2500 hours each year. Utilizing this sunlight to directly illuminate the interiors of office buildings could save over 50% of lighting energy costs during daylight hours, while allowing workers to work under a higher-quality light. In addition, such sunlight could be used to illuminate underground spaces such as subways, utility areas, mines, to illuminate interior plantings, and illuminate underwater areas such as offshore oil and gas drilling rigs. Greenhouses may benefit from the ability to close and insulate their buildings, while still maintaining solar illumination for their plants. For office buildings, simple concepts such as skylights are not practical in most high-rise buildings, and so various methods have been considered to transport concentrated sunlight from outside office buildings to illuminate interior spaces. Because of the inefficiency of typical mirrored surfaces, some solutions to this problem have revolved around the property of total internal reflection.

One method for illuminating interior environments includes the use of light guides using total internal reflection. According to this principle a transparent core of material with a high index of refraction is surrounded with a cladding of material that has a markedly lower index of refraction. Light entering this core at a low angle to the axis of the core is reflected off the interface between the core and cladding with a very high efficiency, allowing efficient light transmission, even in a curved tube, and for long distances. This principle is used in all common fiber optic communications systems. Previous forms of these light guides for interior lighting include bundled glass or acrylic fiber optics.

Bundled glass or acrylic fiber optics are expensive, fragile and cannot easily support the cross-sectional area required to efficiently transport large solar energies. By way of example, U.S. Pat. No. 5,285,513 issued to Kaufman et al. describes a cable for use in transmitting optical telecommunications data. The cable has a core of bundled, coated fibers that are surrounded by a mixture of mineral oil, styrene ethylene propylene polymer, and a fumed silica gelling agent. The mixture functions as a waterblocking material that minimizes intrusion of water into the cable.

Light collection and diffusion devices may be coupled with light guides for the transmission and delivery of light. Light collection devices used to gather sunlight may track the sun or be nontracking, as well as focusing or nonfocusing. Non-focusing concentration systems include walls with a plurality of small flat mirrors that are steerable toward the end of a light guide, such as an optical cable. For example, U.S. Pat. No. 6,227,673 to O'Hara-Smith describes the use of spherical or hemispherical reflectors positioned between flat reflective plates. The flat reflective plates need not track the sun directly, and are computer controlled to maximize the solar radiation impinging on the upper ends of the liquid filled light guides for communication of light to fiber optic cables. U.S. Pat. No. 6,059,438 to Smith et al. describes a sunlight collection system that does not track the sun. A prismatic stack of fluorescent sheets collect and concentrate non-tracked sunlight into a light guide. The light guide may be an optical cable with a rectangular cross section having a fairly large aspect ratio greater than about 4.

Another sunlight collection system that is non-tracking is disclosed in United States U.S. Pat. No. 6,274,860. In this patent, a holographic planar concentrator is used for collecting and concentrating sunlight. This system has the advantage, aside from not requiring solar tracking, of allowing the sunlight to be split spectrally, allowing different wavelengths of sunlight to be concentrated at different spots, which may be selectively gathered for distribution of colored light

After concentrating the sunlight, the sunlight must be allowed to pass into the upper ends of the liquid filled light guide system. To efficiently collect the impinging light, the light must first be at angle within the cone of acceptance of the liquid filled light guide. Light outside the cone of acceptance is not totally internally reflected, and is absorbed or escapes from the liquid filled light guide. In addition, there is loss where the wherever light impinges on the cladding rather than the core of the liquid filled light guide. U.S. Pat. No. 5,806,955 describes the use of Total Internal Reflection (TIR) lenses that direct gathered light towards an optical fiber waveguide. Present systems for use in collecting and distributing natural light do not provide sufficient intensity of light for acceptable illumination of building interiors, are too expensive, do not transport the optical frequencies evenly, are too fragile for long term use, and may contain materials that are too dangerous for use in their required environments.

### SUMMARY

The present invention overcomes the problems outlined above and advances the art by providing a light collection and distribution system capable of distributing light that is of acceptable intensity, safety, spectrum, stability and cost for use in illuminating the structural interiors, such as those of buildings, subways, utility areas, mines, interior plantings, greenhouses, and underwater areas, such as offshore oil and gas drilling rigs. These advantages are economically obtained by utilizing a liquid-filled light guide.

Flexible light guides using a transparent liquid at their core have the advantage of potential low cost and large cross sectional area. Unfortunately, most liquids do not transmit light well across all visible optical wavelengths, are expensive, or their accidental release into an interior environment would be hazardous. In addition, a present limitation of flexible light guides in large scale interior lighting projects is that by their nature they cannot be cut to length easily, and cannot be divided to distribute lighting to where it is needed, or combined with other illumination means to allow use of multiple sources of light. By distributing the light collected from both natural and artificial sources, and having the ability to adjust the light intensity for any end fixture at the source, this light guide system has the advantage over traditional electrical lighting where a completely new fixture is required when lighting needs change.

A further problem is overcome through the use of special packing coupler assemblies. Prior light gathering devices focus sunlight or artificial light onto a group of cylindrical light guides, which loses a large percentage of light in the spaces between guides. Cooling the upper end of a liquid filled light guide or group of light guides is also beneficial where the liquids are volatile, or to prevent unnecessary heat transmission to interior spaces or, conversely, not cooling the upper ends to allow heat transmission (i.e. a seasonal decision). Heat management is also facilitated by the addition of optical filters that have a pass band only in the visible spectrum. Liquids having the properties of heavy mineral oil overcome these problems, and mineral oil is the preferred medium for filling the liquid-filled light guides.

The light collection and distribution system includes a solar collector for use in gathering sunlight and a light dispersion device capable of dispersing light collected by the solar collector for illumination purposes. The liquid-filled light guide is connected to the solar collector and the light dispersion device for transmission of light from the solar collector to the light dispersion device. The liquid filled light guide preferably contains mineral oil as the liquid.

An artificial illumination source, such as an incandescent, fluorescent, or mecury vapor light may be coupled with the liquid filled light guide for use in providing artificial light when sufficient sunlight for illumination purposes is unavailable. A liquid-filled joiner-coupler is used to combine light from the solar collector and the artificial light source into a single pathway for this purpose. Alternatively, the artificial source can be mechanically or optically moved into the optical path of the sunlight to employ the same optical coupling configuration already used to collect sunlight.

The liquid-filled light guide may contain a plurality of segments that are coupled to one another, for example, in male-female interengagement for ease of assembly. These segments may include long tubes, as well as liquid-filled splitter-couplers and joiner-couplers that are, respectively, used to split and join light transmission pathways. The liquid filled light guide may be formed of a tubular outer sheath, a tubular inner lining, and mineral oil filling the tubular inner lining.

The solar collector can be any type of collector, such as a parabolic dish, fresnel lens, or even a system of actuable mirrors under computer control to produce an optimum intensity of reflected light at a collection locus. A packing coupler having ends of a packable geometric configuration may be used to diminish losses as the solar radiation or artificial illumination impinges on the ends of the liquid filled light guides, which may be cylindrical. In addition, the ends may have shaped lenses of the same packable geometric shape to further change the angle of incidence of incoming light such that less light is lost at the edges of multiple light guides.

The light dispersion device can contain a dispersion lens for uncollimating light, and may also be configured as a reflective interior lighting system, for example, one that reflects light back into a room from a ceiling. The light dispersion system may be changed at the output end easily, providing tremendous flexibility in determining the lighting pattern for an interior environment.

Segments of the light collection and distribution system may be coupled at junctions formed of a male end and a female end joined to form a vacuity. A light transmissive medium other than air fills the vacuity to diminish transmission losses at the junctions. Preferably, at least one hole communicates the vacuity through a wall of the light guide to permit filling of the vacuity with the light transmissive medium. A tubular sheath seals the hole to prevent leakage of the light transmissive medium.

An interior environment may be retrofitted, or installed as part of a new construction, with the light collection and dispersion system according to the steps of

installing a solar collector at a location capable of gathering sunlight;

installing a plurality of light dispersion devices; and

coupling the solar collector and the light dispersion devices with a liquid-filled light guide to establish a light transmissive pathway between the solar collector and the light dispersion devices.

The liquid light guide system allows the transmission of a high percentage of the visible optical spectrum, while reducing the amount of undesirable ultraviolet and infrared transmission, while being inexpensive and safe for use in interior environments. The foregoing instrumentalities allow the production of liquid light guides in a few standard lengths, and allow the distribution of this light through the splitting of the light in couplers that connect a single light guide to a plurality of light guides, and the combining of light in couplers from a plurality of light sources.

The liquid-filled light guide is part of a light collection and distribution system that may include devices for concentrating sunlight, for focusing sunlight, for tracking the sun, for cooling the upper ends of the liquid-filled light guides where the suns rays are directed onto them, for filtering, reflecting, or bypassing non-desirable optical spectrum, for packing the liquid light guides in a fashion to increase the efficiency of the sunlight or artificial illumination collection, and for radiating, dispersing, directing, or diffusing the light at the output end. A packing coupler for trasmissive input to the liquid-filled light guides increases the efficiency of sunlight collection by couplers that transform a 2D packable shape into a 2D circular cross section light guide.

The present invention solves significant problems in this field by providing a liquid-filled light guide that transmits light efficiently across all visible optical wavelengths, and by providing a coupling system that will allow a few limited lengths of light guide to be joined in segments to form the required length, by providing a splitting coupler that will allow the efficient distribution of light, by providing a combining coupler that will allow the use of a plurality of light sources, by providing a packing coupler to allow efficient collection of light, by methods for cooling the front end of the liquid filled light guide system, and by methods for dispersing the light at the terminus of the light guide system.

### BRIEF DESCRIPTION OF THE DRAWINGS

FIG. 1 is an axial midsectional view of an elongated liquid-filled light guide;

FIG. 2 is a midsectional view providing additional detail of input and output ends of the liquid filled light guide;

FIG. 3 is a midsectional view of the input and output ends of a liquid filled light guide as described in FIG. 1 showing details of the coupling between these ends;

FIG. 4 is a midsectional view of a splitter-coupler for a liquid filled light guide;

FIG. 5 is a midsectional view of a splitter-coupler incorporating partially reflective optical elements;

FIG. 6 is a midsectional view of a splitter-coupler designed to split incoming light into a plurality of outgoing liquid light guides;

FIG. 7 is a midsectional view of a joiner-coupler used to combine two separate sources of light;

FIG. 8 is a diagram showing the use of liquid filled light guides, solar concentrators, artificial light sources, combining couplers, splitter couplers and dispersion devices in the illumination of interior areas of an interior environment;

FIG. 9 depicts a solar collecting device for concentrating sunlight;

FIG. 10 depicts a second solar collecting device;

FIG. 11 depicts a third solar collecting device;

FIG. 12 depicts a packing coupler that combines input lenses in a packed configuration to avoid input losses;

FIG. 13 is a midsectional view of a packing coupler element; and

FIG. 14 depicts a plurality of light diffusers that are used to illuminate an interior space.

### DETAILED DESCRIPTION

There will now be shown and described a liquid-filled light guide system for use in indoor, underground, or underwater lighting. The liquid-filled light guide contains an outer sheath, an inner lining and a light transmissive medium that is a clear mineral oil having a high refractive index, low dispersion, and long attenuation length. The liquid-filled light guide is selectively coupled with coupler—splitters, light collectors, and light diffusers to install the system between a solar exposed area and an interior environment. The discussion below demonstrates, by way of example and not by limitation, various embodiments and instrumentalities of the light gathering and distribution systems that contain liquid-filled light guides. Like numbering of identical elements is retained throughout the respective figures.

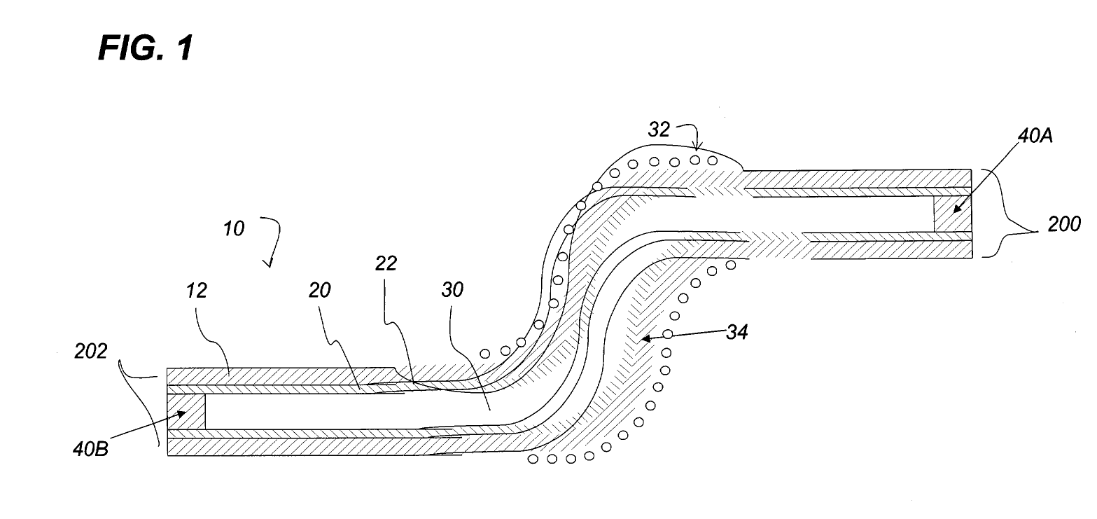

FIG. 1 shows a midsectional view of liquid-filled light guide 10. The liquid-filled light guide 10 is circumscribed by an outer sheath 12, which, in the preferred embodiment, is tubular and provides inexpensive structural support to the liquid-filled light guide 10. The outer sheath 12 need not have any particular optical properties. An inner lining 20 is bonded to the outer sheath 12 at interface 22. The inner lining 20 is also tubular and is filled with a light transmitting medium 30. The preferred design selection properties of the outer sheath 12 are that it can be bonded well to the inner lining 20, for example using plastic cement at interface 22 or mechanical bonding processes during tube manufacture, and does not react with or dissolve the inner lining 20. The inner lining 20 and the outer sheath 12 are not required to have the same cross sectional shape.

The inner lining 20 is, for example, composed of a non-reactive material of very low refractive index, such as fluorinated ethylene polymer (FEP). Any other material may be selected having a low refractive index, e.g., less than 1.40, low reactivity with the light transmitting medium 30, and the ability to bond with selected material for the outer sheath 12. Other such materials include but are not limited to perfluoropolymers such as polytetrafluoroethylene PTFE, perfluoroalkoxy (PFA) Cytop (a cyclized transparent optical polymer obtained by copolymerization of perfluoro (alkenyl vinyl ethers), produced by Asahi Glass, Co. Ltd), Teflon AF-1600, Teflon AF-2400, and 3M Flourad 722, 724 and 725. Walls of the inner lining 20 may be as thin as practical, and are preferably less than 10 mil, and potentially as thin as 0.5 mil. The inner lining 20 is preferably smooth and free of defects.

In some embodiments, the liquid-filled light guide 10 uses just the inner lining 20 and no outer sheath 12, provided the inner lining 20 has sufficient strength for structural support of the liquid-filled light guide 10. The inner lining 20 and the outer sheath 12 are preferably flexible, which facilitates routing the light guide for installation, but may also be constructed of rigid, semi-rigid, or any combination of rigid, semi-rigid and/or flexible materials. The use of rigid or semi-rigid materials may benefit installation to assure that bends and curves do not exceed that allowed for total internal reflection of light of visible optical wavelengths within the light transmitting medium and inner lining. A wound coil 32 may be positioned around bends, such as bend 34, to prevent kinking and consequent disruption of light transmissivity through the light transmissive medium 30.

The form of the liquid filled light guide 10 shown in FIG. 1 is cylindrical; however, other forms are possible, such as light guides with a square, hexagonal, octagonal or other polygonal, elliptical or rhomboidal cross section. In addition, the form of the inner lining 20 and outer sheath 12 may be different to meet certain structural requirements.

A preferred form of the light transmitting medium 30 is a transparent mineral oil having a high refractive index near 1.47. High density mineral oils having a specific gravity generally in excess of 0.85 also generally have high refractive indices. Those having a specific gravity ranging from 0.81 to 0.89 are preferred. The mineral oil should also have a low level of optical dispersion, and a long attenuation length for visible optical wavelengths. The mineral oil may contain various additives, for example, antioxidants or preservatives including tocopherol, a phenol, a hindered phenol, sulfides, phenol sulfides, amines, and combinations of these materials. These antioxidants or preservatives may be present in low concentrations of less than 2% by weight that do not significantly impair light transmissivity. As used herein, attenuation length is defined as the distance light travels in a medium before the power of transmitted light is reduced 1 dB. Mineral oils that have been found suitable for the light transmitting medium 30 include Superla 5™ by Amoco, Drakcol 7™ by Pennreco, Duoprime 70™ by Lyondell, Scintillator ™ fluid by Witco, and pharmaceutical grade mineral oils sold by Sigma and Aldrich. Attenuation length properties and reduction of optical dispersion are enhanced by filtering the mineral oil to 1 micron, and by de-gassing the mineral oil under vacuum.

Capping each end of the liquid-filled light guide 10 are light transmissive caps 40A, 40B. The light transmissive caps 40A, 40B may be made of a polymer or glass that has highly polished surfaces and has a index of refraction which is substantially similar, i.e., within 20 percent of that for the light transmitting medium 30, when the light transmissive cap 40A, 40B is intended to be on an end coupled to another liquid filled light guide. This similarity of refractive indices permits light to pass through the light transmissive cap 40A or 40B with a minimum of reflection and loss. When the light transmissive cap 40A, 40B is used to couple light being transmitted in air to light being transmitted in transmitting medium 30, then the material used for the light transmissive cap 40A or 40B should preferably have a index of refraction that minimizes the total reflection losses due to index-of-refraction change at both the (air)/(light transmissive cap) and (light transmissive cap)/(transmissive medium) interfaces. Other suitable materials for the light transmissive caps 40A, 40B include, but are not limited to, certain Teflons, polycarbonates, pyrex, quartz and quartz glass.

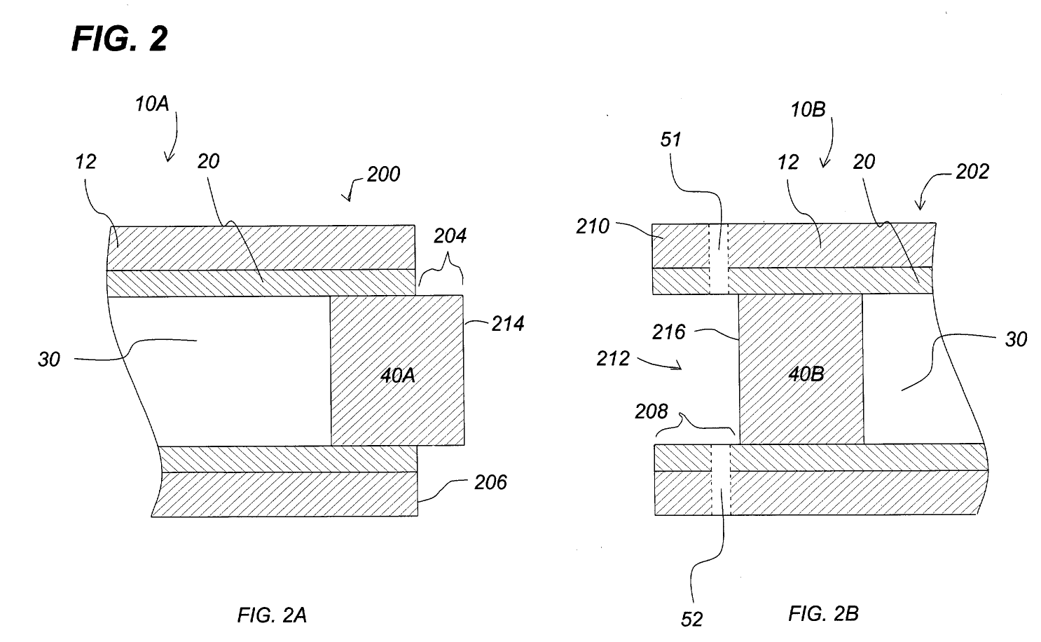

FIGS. 2A and 2B show, respectively, longitudinally taken midsectional views of an output end 200 and an input end 202 that may be used on the liquid-filled light guide 10 shown in FIG. 1. Generally, these features facilitate coupling of the output end 200 of one light guide 10A to the input end 202 of another light guide 10B. The light guides 10A, 10B may each be identical to light guide 10 shown in FIG. 1 or they may differ in length. For the output end 200 of the light guide 10A, as shown in FIG. 2A, the light transmissive cap 40A extends a short distance 204 past the end 206 of the outer sheath 12 and inner lining 20 of the light guide 10A. For the input end 202 of the light guide 10B, as shown in FIG. 2B, the light transmissive cap 40B is inset a distance 208 from end 210 into inner lining 20. At the input end 202 of the light guide 10B, holes 51 and 52 are small holes drilled through the outer sheath 10 and inner lining 20. When the light transmissive cap 40A is inserted into recess 212, these holes 51, 52 are adjacent the light transmissive cap 40A.

In some embodiments, output surface 214 contacts input surface 216 when the light transmissive cap 40A is inserted into recess 212. In preferred but optional embodiments, surfaces 214, 216, are separated by a small distance to assure that ends 206, 210 contact one another in providing continuity between the outer sheath 12 and the inner lining 20 at the boundary between ends 206, 210. Accordingly, the distance 204 that the light transmissive cap 40A extends past end 206 may be less than the distance 208 that the light transmissive cap 40B is inset into the light guide input end 202.

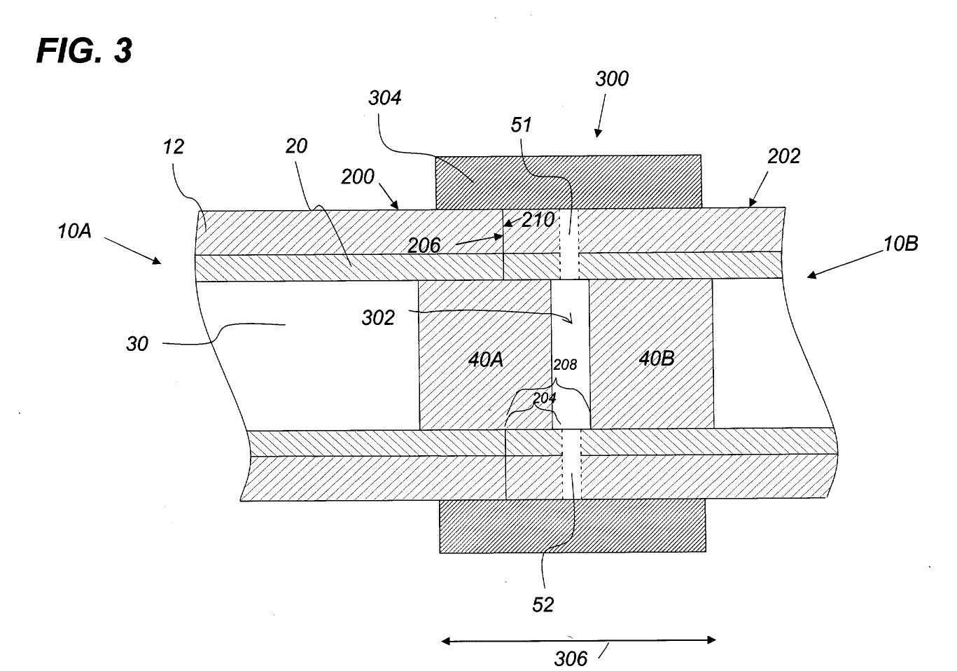

FIG. 3 is a midsectional view of a junction 300 formed between the input end 202 and output end 200 of the liquid filled light guides 10A, 10B. When the output end 200 of the light guide is coupled to the input end 202, a small vacuity 302 exists initially between the light transmissive elements 40A, 40B. During coupling, mineral oil constituting the light transmissive medium 30 is introduced into vacuity 302 through one of holes 51, 52. The other of holes 51, 52 is subjected to a hard vacuum of less than 1 Torr, which draws the light transmissive medium 30 into the vacuity 302. Upon a complete filling of the vacuity 302, a coupling sheath 304 is glued to or mechanically attached to the outside of the junction 300, sealing both the wall joint at ends 206, 210 and the holes 51 and 52 against leakage of either air from the outside or light transmissive fluid 30 from vacuity 302. Coupling sheath 304 is optionally a compression fitting that slides axially in either direction of pathway 306 to facilitate periodic servicing by renewal or replacement of the light transmissive medium 30.

The provision of vacuity 302 and the filling of vacuity 302 with the light transmissive medium 30 at junction 300 allows the transmission of light through the junction 300 with minimum loss. Nevertheless, maintenance and installation may be expedited at a level of acceptable loss if the dimensions of vacuity 302 are reduced to a minimum and the vacuity 302 is filed with air.

It is also anticipated that liquids or gels other than mineral oils could be used to fill vacuity 302, since the cost of the light transmitting medium 30 is inconsequential for filling this small vacuity. These other liquids or gels preferably have low dispersion and an index of refraction that closely matches that of the light transmissive elements 40A, 40B. Optical glues may also be employed to provide the high-efficiency optical path required through vacuity 302.

It is contemplated that the coupling sheath 304 may alternatively be created in two halves (not shown), one half attached to each end of the light guide. The two halves may be mechanically joined during coupling, for example, in a threaded union, clip-latch mechanism or quarter-turn locking assembly (not shown). In this coupling embodiment, a male-to-male coupling may be employed and the two segments coupled by the use of threaded mechanical fasteners. (not shown) With this configuration, the end caps on the liquid filled light guide are optically flat. A thin film of the transmission medium or other optically appropriate material is spread on the contacting surfaces. The use of threaded fasteners serves to align the two end caps and when tightened to a predetermined number of ft-lbs, forces any remaining air between the end caps. The thin film of material on the contacting surfaces acts as a gasket and provides a homogenous interconnect. This approach has additional loss components due to a less than uniform set of indicies of refraction at the inner and outer sheath.

Junction 300 facilitates the passage of light with a minimum of optical loss or dispersion. The light transmissive medium 30 in both light guides 10A and 10B, and in the vacuity 302 has essentially the same refractive index as do the light transmissive caps 40A, 40B. As shown in FIG. 3, output end 200 is a male member and input end 202 is a female member. The male-female structure may be inverted such that output end 200 has the female structure shown on input end 202, and vice-versa. The male-female interengagement of light transmissive cap 40A over distance 204 minimizes loss of transmitted light. Polishing all surfaces of light transmissive caps 40A and 40B, as well as the vacuum-sourcing of light transmissive medium 30, further diminishes transmission losses across junction 300 that, otherwise, could occur due to scattering of light.

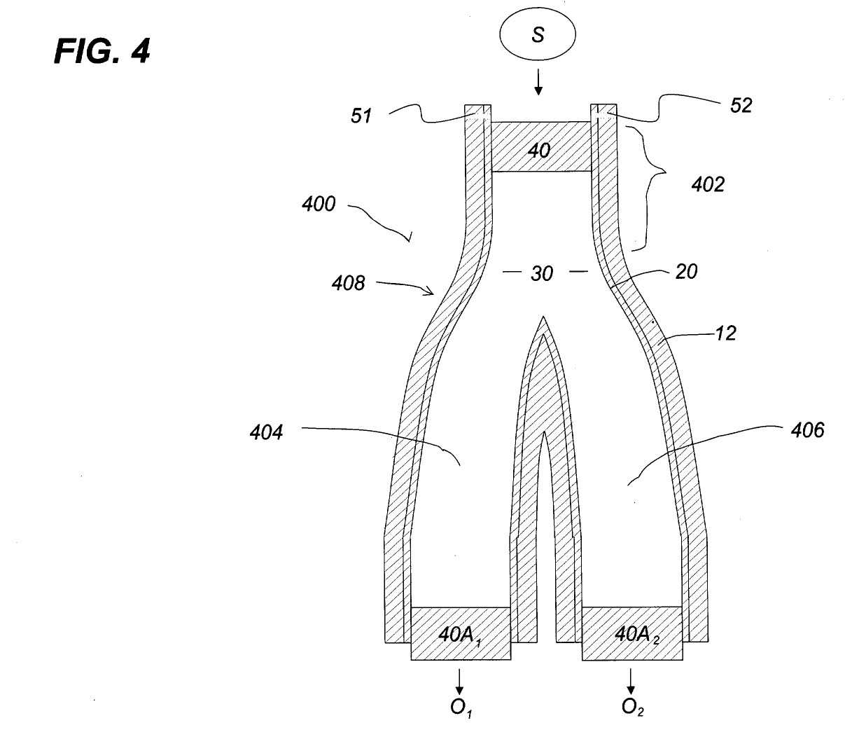

The provision of junction 300 allows light guides 10A, 10B to be installed over any distance by the coupling of a smaller number of standard light guide lengths. The liquid-filled nature of the liquid filled light guides 10A, 10B prohibits ‘cutting to length’, and by this coupling method there is avoided a need to manufacture individual light guides to the lengths required for a specific project. However, a mobile “cut and fill” station is contemplated that allows for field customization of liquid filled light guides. FIG. 4 shows a splitter coupler 400 formed as a Y that distributes light from a single light guide section 402 in branched optical communication with two light guides 404, 406. In some embodiments, branched pathways like splitter-coupler 400 facilitate the distribution of light from a single source S to a plurality of outputs O₁, O₂. This branching allows the centralized collection of solar power or artificial light from source S, and the subsequent distribution of this light to, for example, specific areas in an interior environment that are respectively allocated to outputs O₁, O₂. Curvature of the splitter coupler at branch juncture 408 should not exceed the maximum allowed for total internal reflection between the light transmissive medium 30 and the inner lining 20. Light transmissive caps 40A₁, 40A₂ are identical to light transmissive cap 40A shown in FIG. 2.

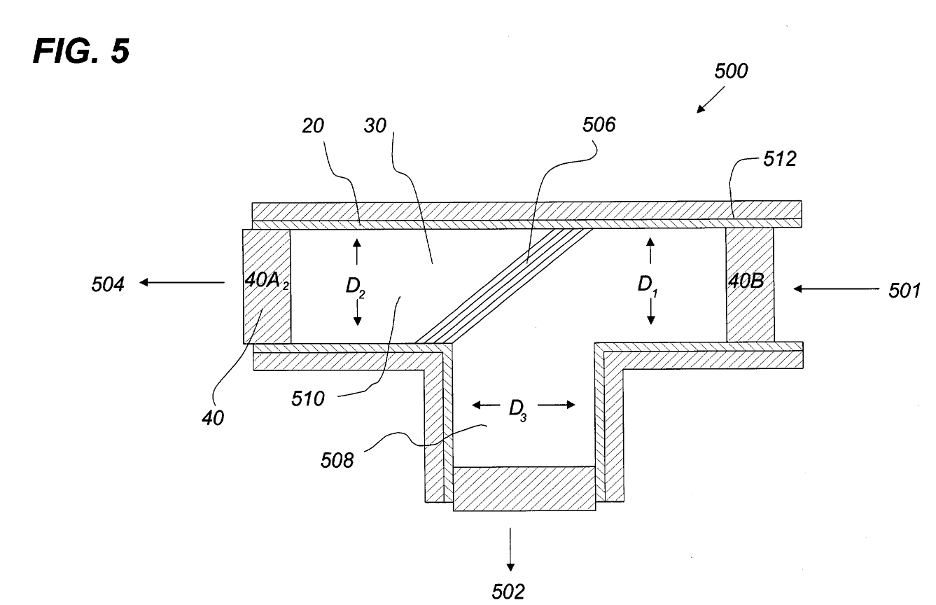

FIG. 5 shows splitter coupler 500. Incoming light 501 is split into two paths 502, 504 by means of a partially reflective/partially transmissive optical element 506. This optical element 506 is positioned to reflect a portion of the incoming light 501 on path 502 into an output guide 508. The unreflected portion of incoming light 501 on path 504 is transmitted through the optical element 506 and into output guide 510. Diameter D₁ in an incoming light guide segment 512 may differ from diameters D₂ and D₃ in the output guides 508, 510. Diameters D₁ and D₂ may differ from one another, such that cross-sectional areas of the incoming light guide segment 512 and the output guides 508, 510 may all differ from one another.

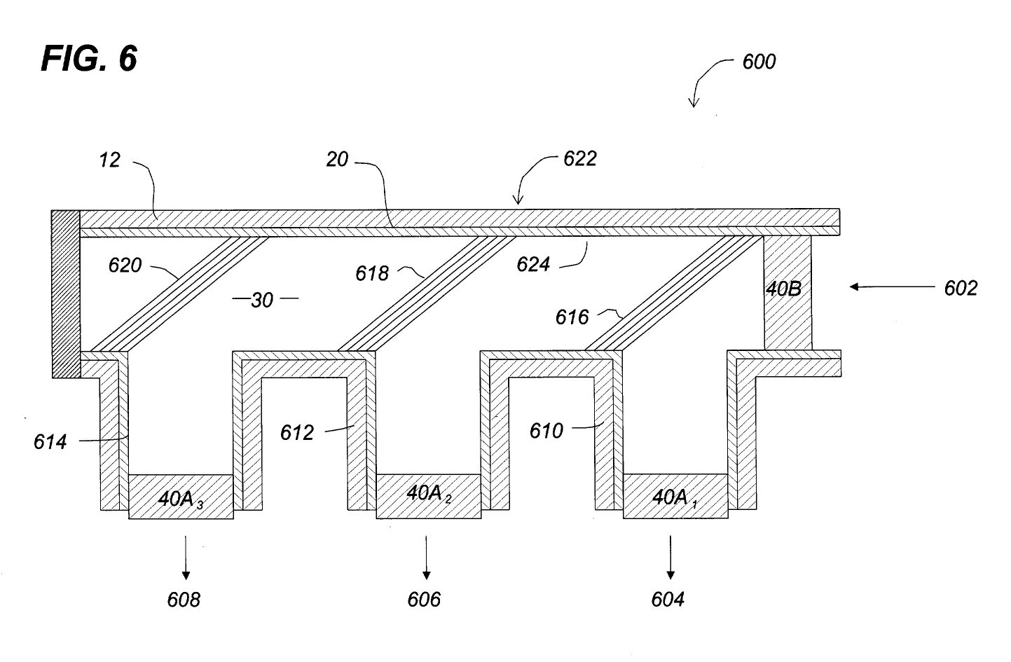

FIG. 6 shows a splitter-coupler 600. Incoming light 602 is progressively split into a plurality of paths 604, 606, 608 in corresponding output guides 610, 612, 614 by the action of partially reflective/partially transmissive elements 616, 618 and 620. By way of example, optical element 616 may be 33% reflective, optical element 618 50% reflective, and optical element 620 is 100% reflective to provide the output light guides 610, 612, 614 with approximately equal amounts of light on paths 604, 606, 608. The output guides 610, 612, 614, and the input guide segment 616 may differ from one another in cross-sectional area and diameter. The reflectance of partially reflective/partially transmissive elements 616, 618 and 620 may be selectively adjusted for allocation of incoming light 602 into paths 604, 606, 608. In alternative embodiments, the partially reflective/partially transmissive elements 616, 618 and 620 may be eliminated with distribution of light accomplished via coating internal surface 624 with a total internal reflection-capable surface, and the junctions between incoming light 602 and outgoing optical paths 604, 606, and 608 are curved to meet the requirements of Total Internal Reflection within the splitter-coupler. Light transmissive caps 40A₁, 40A₂, 40A₃ are identical to light transmissive cap 40A shown in FIG. 2

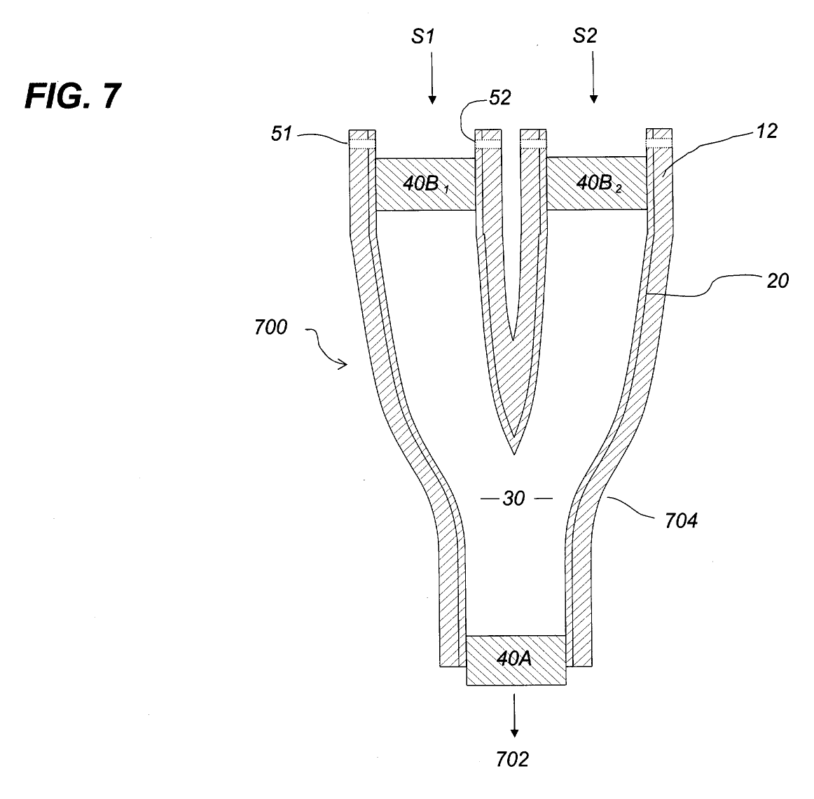

It is also possible to combine two or more separate sources of light into a single light guide. FIG. 7 shows a coupler-splitter 700 that combines input from two sources of light S₁, S₂ into a single path 702. The curvature 704 should not exceed the maximum allowed for total internal reflection between the light transmissive medium 30 and the inner lining 20. Light transmissive caps 40B₁, 40B₂ are identical to light transmissive cap 40B shown in FIG. 2.

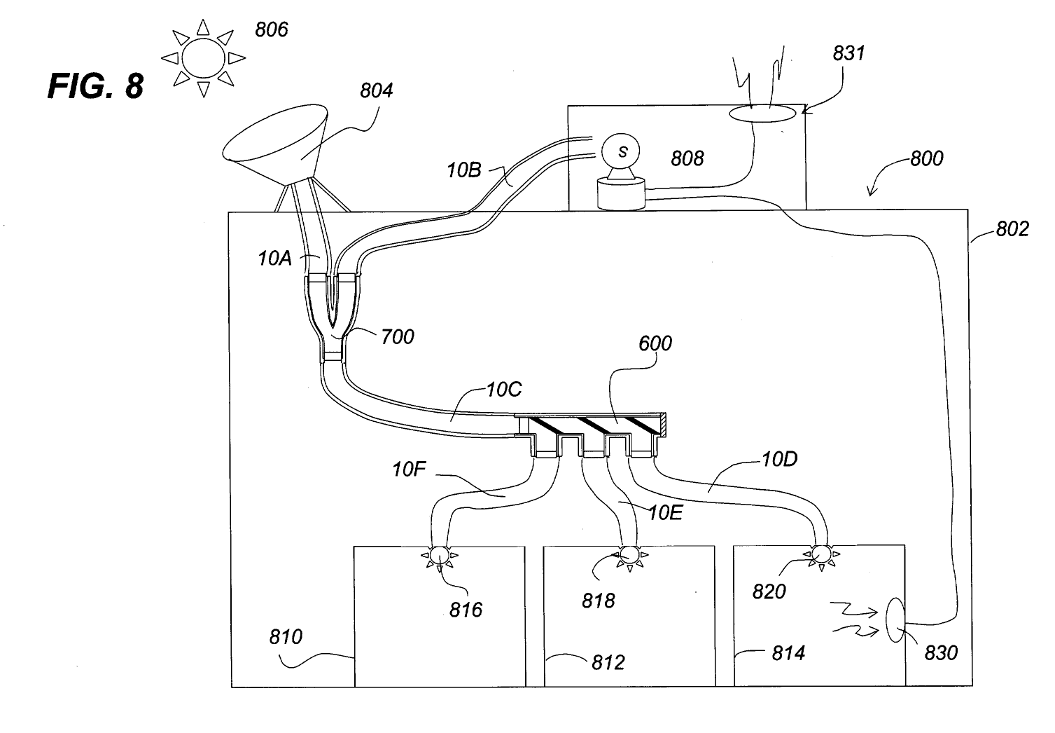

FIG. 8 shows a light collection and distribution system 800 that incorporates structures shown in FIGS. 1-7 for distribution of light throughout an office building 802. A solar radiation collector 804 is used to collect and concentrate sunlight 806 for input to a liquid filled light guide 10A. An artificial light source 808 is provided for nighttime use, or as a supplement when sunlight 806 is insufficient, and provides light to light guide 10B. Sunlight 806 and light from artificial light source 808 is combined in coupler-splitter 700, which supplies light to light guide 10C. In turn, light guide 10C carries light to splitter-coupler 600, which divides the light for distribution into light guides 10D, 10E and 10F. The light guides light guides 10C, 10D, 10E, and 10F have the same structure as light guide 10 shown in FIG. 1, but may differ in length and cross-sectional area. These cross-sectional areas should be sufficient for transmission of light. In preferred embodiments, it is contemplated that the cross-sectional areas are sufficient to meet the demand for transmission of light that is gathered by solar radiation collector 804 without overheating the internal mineral oil. These cross-sectional areas are usually equivalent to the area of a tube of circular cross-section having a diameter ranging from about one-half to four inches, with the most common diameter being about one inch. Light guides 10D, 10E and 10F carry light for distribution into interior spaces 810, 812, 814 by the action of terminal diffusers 816, 818, 820.

Alternatively, artificial light source 808 can be set up to be mechanically moved into the optical path (not shown) of the collector 804 based on inputs from sensors 830 and 831. This eliminates the need for coupler-splitter 700 and increases the efficiency of transmission. This embodiment uses the same front-end collection and cooling system and may reduce total installation costs.

The efficiency of a light collection and distribution system 800 may be enhanced by incorporating structures within the solar radiation collector 804 for concentrating sunlight, for focusing sunlight, for tracking the sun, for cooling light guide 10A where the suns rays are directed, for packing the liquid light guides in a fashion to increase the efficiency of the sunlight collection, and for radiating, dispersing, or diffusing the light at the terminal diffusers 816, 818, 820. Light sensors 830 and 831 may be used to detect ambient light and control the artificial light source 808 to maintain even illumination of interior spaces 810, 812, and 814.

Similarly, FIG. 8 could be drawn such that solar collector 804 concentrates sunlight on a bundle of liquid-filled light guides, and said light guides transport light directly to diffusers 816, 818 and 820 without the need for splitter-couplers 600 and 700, potentially increasing efficiency of transport.

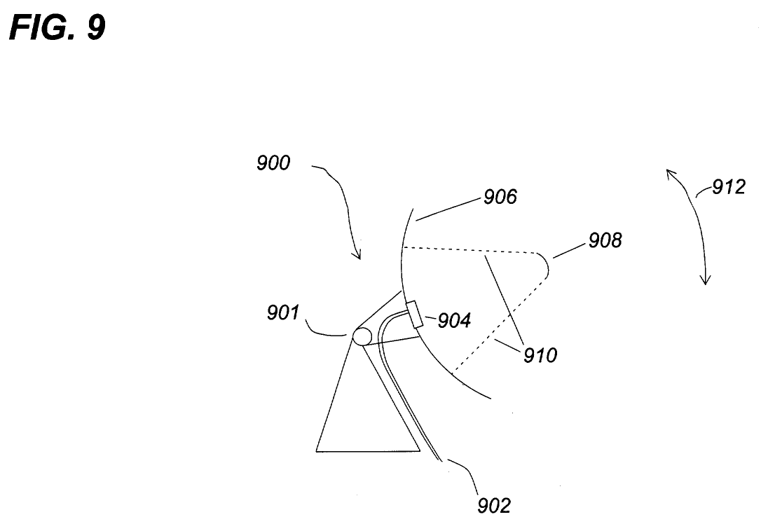

FIG. 9 shows a solar concentrator 900 that works on the principal of focusing sunlight into a bundle of liquid-filled light guides 902 that may include one or more of the light guides 10. Solar concentrator 900 uses a conventional solar tracking system 901 to follow the sun and maintain the focus of sunlight onto a central lens 904 that feeds the bundle of liquid-filled light guides 902. Solar concentrator 900 utilizes a Schmidt-Cassegrain reflective design for focusing and concentrating sunlight. In this design, sunlight impinges on the reflective, parabolic dish 906. The light is reflected with parabolic focus onto a smaller reflective mirror 908, which is supported by supports 910. Mirror 908 focuses and concentrates the solar radiation onto lens 904 for delivery to the bundle of liquid-filled light guides 902. The solar tracking system 901 allows the dish to follow the sun, e.g., by a timed movement along arc 912 to maintain focus for optimal solar concentration effects.

In alternative embodiments, parabolic dish 906 can directly reflect light onto lens 904 positioned in place of mirror 908 or even at a focus not attached to the solar concentrator 900. Lens 904 is not required, and focus may occur directly onto upper ends of the bundle of liquid-filled light guides 902 located in place of lens 904.

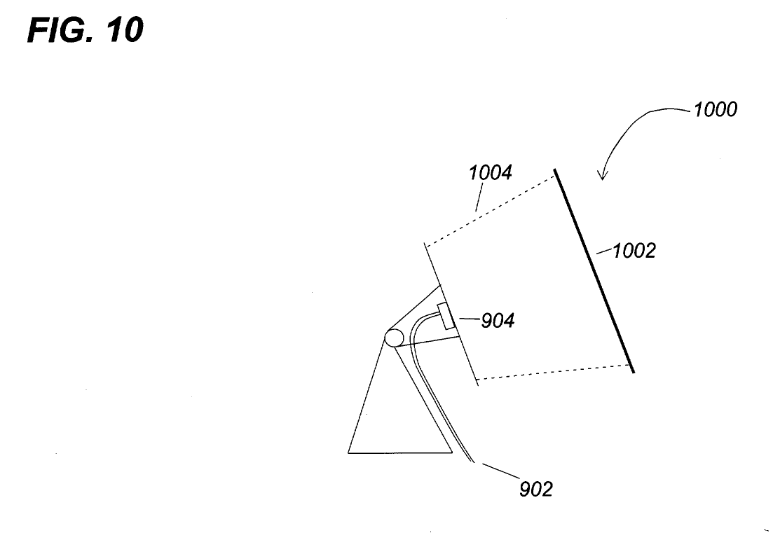

FIG. 10 shows an alternative solar concentration system 1000 that utilizes a fresnel lens 1002 supported by struts 1004 to focus sunlight directly on lens 904.

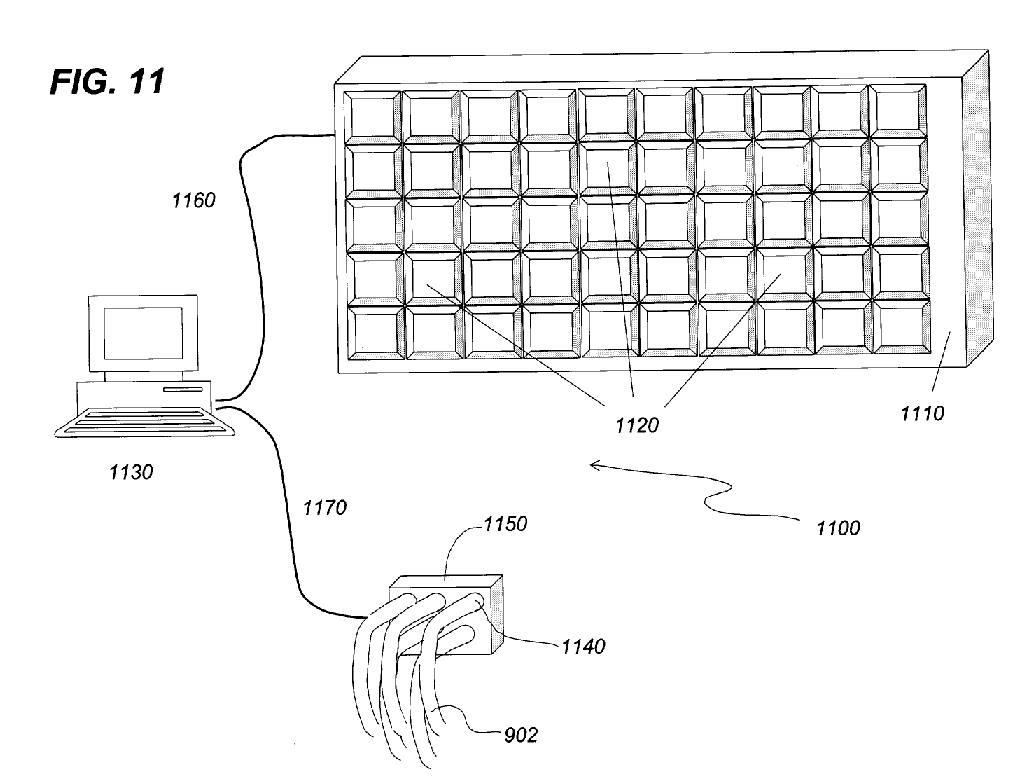

FIG. 11 shows a light gathering device 1100 that does not require focusing the suns rays. Wall 1110 supports a multiplicity of flat mirrors 1120. Each of these mirrors 1120 is independently steerable in three dimensions, and under the control of computer 1130. The computer 1130 is also connected to light energy sensors 1140 located on the upper ends of the bundle of liquid-filled light guides 902. The computer 1130 positions each mirror in the multiplicity of mirrors 1120 to maximize sense signals corresponding to reflected light energy so that the solar energy arriving at block 1150 is maximized. A representative liquid-filled light guide 1140 is shown leaving the upper end block 1150. Thus, the multiplicity of mirrors 1120 concentrate, but do not focus, the solar radiation onto block 1150 for delivery into the bundle of liquid-filled light guides 902. The sun is not explicitly tracked.

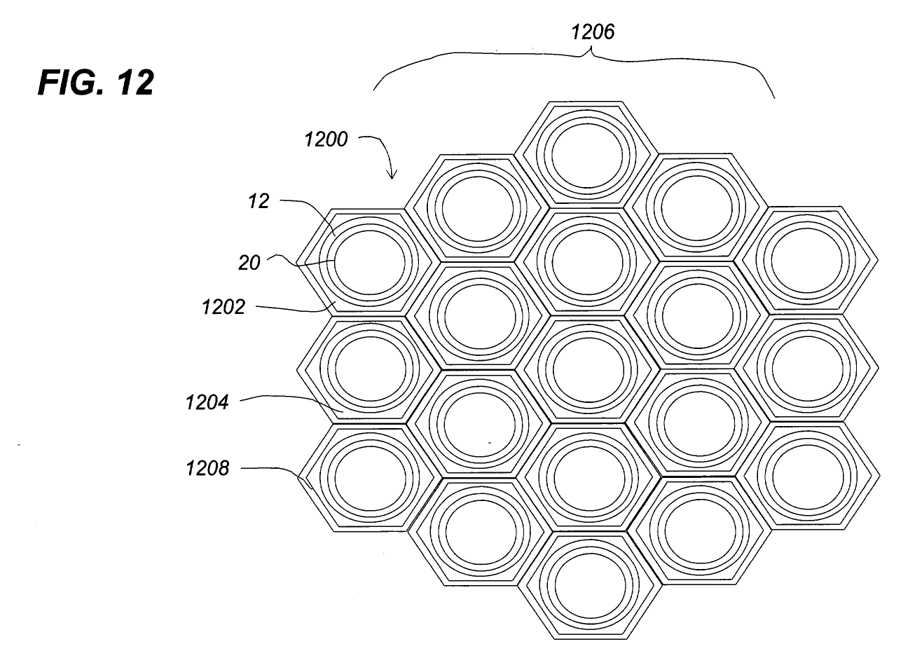

FIG. 12 is a front elevational view of a packing coupler 1200. A plurality of hexagonal lenses 1202, 1204 interfit across a broad areal extent 1206. Thus, the lenses 1202, 1204 are packed across the areal extent 1206 in a manner that more fully occupies the spatial dimensions of areal extent 1206 than does the surface area occupied, for example, by light transmissive liquid 30 in communication with lens 1202. Lenses 1202 and 1204 could be replaced by flat optical elements such as the light transmissive cap 40B in FIG. 1. It is contemplated that the hexagonal cross section of 1202 could be replaced with any shape such that multiple coupling could be packed together with a minimum of optical loss. Such shapes could include various regular and irregular polygons and certain elliptical shapes in place of the hexagonal shape of lenses 1202, 1204. Lenses 1202, 1204 are circumscribed by a heat-conductive material 1206 that is used to dissipate heat. The packing coupler 1200 may be used in place of lens 904 shown in FIGS. 9 and 10, as well as block 1150 in FIG. 11.

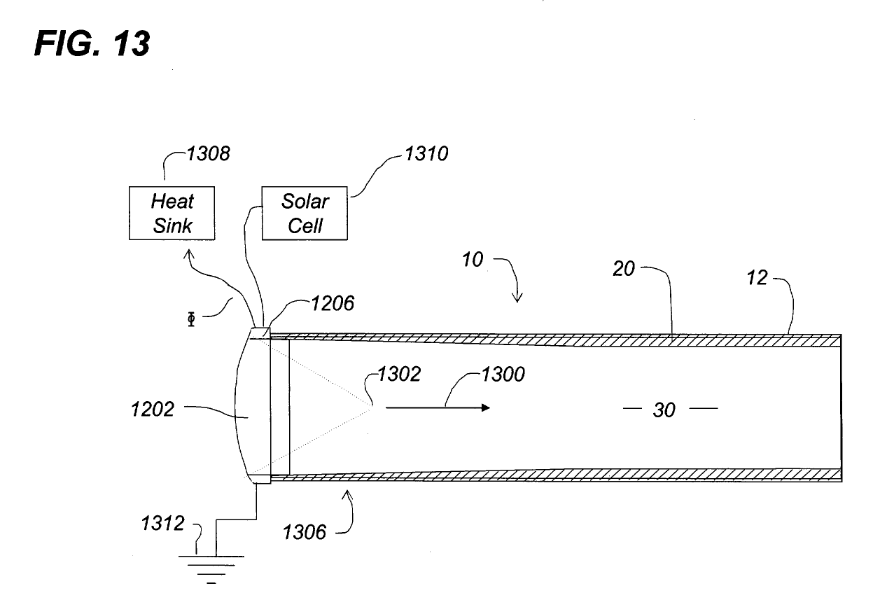

FIG. 13 is a midsectional view of lens 1202 installed on liquid-filled light guide 10. Lens 1202 focuses light onto pathway 1300 through light transmissive liquid 30 and away from the edges of the lens 1202, minimizing the losses of light impinging on the edge of the lens. The lens 1202 is circumscribed by a heat conducting material 1206 that is used to effect cooling of upper end 1306. By way of example, the heat conducting material may be metal in thermal communication with a heat sink 1308 for delivery of heat flux Φ to the heat sink 1308. The heat conducting material 1206 may alternatively be a Peltier effect thermoelectric cooler powered by a solar cell 1310. In the event solar cell 1310 is in use, the heat conductive material 1206 is connected to ground 1312.

Alternatively, heat conducting material 1206 can be made hollow to allow water to flow around lenses 1202 and 1208. The water would carry away excess heat and the then heated water could be pumped into the buildings hot water system, providing a hot water pre-heating system at very low cost. In addition, the hot water could be used for radiative heat in cold weather.

Additional heat management generated by the incident sunlight is possible by adding an optical filter to the lens and heat sink assembly. The optical filter has a pass band in the visible spectrum with all other wavelengths attenuated. This optical filter may also be implemented as a reflective filter (reflecting non-desired wavelengths away from assembly), or a prismatic or TIR lens that directs undesirable wavelengths away from the lens. Of considerable importance is the management of the infrared (IR) wavelengths that transmit heat. In the warmer months, the filter would be in the optical path thereby filtering the IR energy. With the filter thermally potentially coupled to the heat sink, the energy would be prevented from entering the light distribution system resulting in less overall cooling costs for the interior environment. In the winter months, the filter would be removed from the optical path, providing additional heating to the interior environment and thereby reducing the overall heating costs for the interior environment.

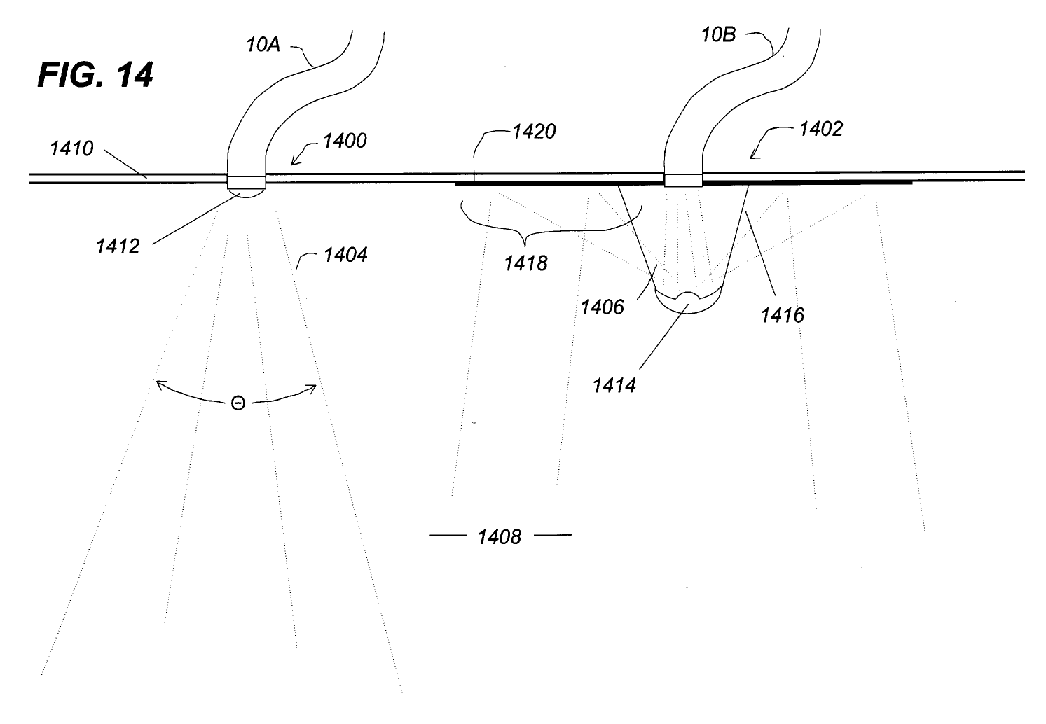

FIG. 14 shows two different light dispersion structures 1400, 1402 for dispersing light 1404, 1406 into an interior space 1408. Liquid-filled light guides 10A, 10B terminate at the ceiling 1410. Light 1404, 1406 initially exiting a liquid filled light guide 10A, 10B is highly collimated, and in uncollimated form is largely unsuitable for normal use. Decollimator 1412 is a lens or other optic that spreads the light into a cone of reasonable angle θ to illuminate a small area, such as a desk (not shown).

Dispersion structure 1402 includes a specially designed mirror 1414, which is supported by struts 1416 away from the ceiling 1410. Mirror 1416 is designed to take collimated light 1406 and reflect it back onto a ceiling area 1418, such that the light arriving at the ceiling area 1418 is evenly distributed. Ceiling area 1418 functions as a diffusive pad and is coated for reflection, e.g., by white paint, to provide soft and even diffusion and dispersion of the light 1406.

Other “light shaping” configurations are possible, providing a wide variety of dispersion effects from the original highly collimated light including spot light and artistic and decorative effects.

There may be instances where an interior area requires reduced lighting or darkness and the present invention provides for a means to control the amount light entering the distribution system thus controlling the amount of light present at the dispersion point. As contemplated herein, the solar collection means provides a method to collect and direct solar energy to the liquid filled light guide aperture. By re-positioning the focal point of the collector, or de-focusing, the amount of light will be reduced. This will have a resulting effect on the interior environment equivalent to “dimming” the light.

An alternative method, which includes preventing any light from entering the light distribution system, includes incorporating a shutter at the liquid filled light guide aperture. The shutter may be positioned to limit the amount of light entering the distribution system, providing a dimming effect or, completely shadow the aperture to prevent any light from entering. This condition will result in darkness in the interior environment. The shutters are independently controlled from within the interior environment to provide the desired level of light. Other methods contemplated for dimming or shutting off light include reflecting the light entering an interior environment directly back into the liquid filled light guide it came from, reflecting light away at the source end of the liquid filled light guides, using spectral and TIR lenses to remove light incoming light from the pathway, and having a section of the liquid filled light guide bend at a sharper angle than that allowed for Total Internal Reflection, such that a portion or all of the light escapes or is absorbed by the light guide lining.

The present invention in its broader aspects is not limited to the specific embodiments shown herein and described. It will be obvious to those skilled in the art that various changes and modifications may be made therein without departing from the scope of the invention as described herein.

1. A light collection and distribution system for use in illuminating the interior of a structure comprising:
a solar collector for use in gathering sunlight,
a light dispersion device capable of dispersing light collected by the solar collector for illumination purposes; and
a liquid-filled light guide connected to the solar collector and the light dispersion device for transmission of light from the solar collector to the light dispersion device.

2. The light collection and distribution system of claim 1, further comprising an artificial illumination source coupled with the liquid filled light guide for use in providing artificial light to the light dispersion device.

3. The light collection and distribution system of claim 2, the liquid-filled light guide comprising a liquid-filled joiner-coupler that combines light from the solar collector and the artificial light source into a single pathway.

4. The light collection and distribution system of claim 1, wherein the liquid in the liquid-filled light guide comprises mineral oil.

5. The light collection and distribution system of claim 4, wherein the mineral oil is a transparent mineral oil having a specific gravity ranging from 0.81 to 0.89.

6. The light collection and distribution system of claim 1, further comprising a structure fitted with the light collection and distribution system to provide internal illumination of the structure.

7. The light collection and distribution system of claim 1, the liquid-filled light guide comprising a plurality of liquid filled light guide segments connected to one another by male-female interengagement.

8. The light collection and distribution system of claim 1, the liquid-filled light guide comprising a splitter-coupler used to divide light into a plurality of optically transmissive pathways.

9. The light collection and distribution system of claim 8, the splitter-coupler including means for dividing light into more than two pathways.

10. The light collection and distribution system of claim 1, the liquid-filled light guide comprising a light guide element including a tubular outer sheath, a tubular inner lining, and the liquid filling the tubular inner lining.

11. The light collection and distribution system of claim 1, the solar collector comprising a parabolic dish.

12. The light collection and distribution system of claim 1, the solar collector comprising a fresnel lens.

13. The light collection and distribution system of claim 1, the solar collector comprising a system of actuable mirrors under computer control to produce an optimum intensity of reflected light at a collection locus.

14. The light collection and distribution system of claim 1, the light dispersion device comprising a dispersion lens.

15. The light collection and distribution system of claim 1, the light dispersion device comprising a reflective lighting system.

16. The light collection and distribution system of claim 1, the light guide comprising junction formed of a male end and a female end joined to form a vacuity, and a light transmissive medium other than air filling the vacuity.

17. The light collection and distribution system of claim 16, the junction defining at least one hole communicating the vacuity through a wall of the light guide to permit filling of the vacuity with the light transmissive medium.

18. The light collection and distribution system of claim 16, further comprising means for sealing the hole to prevent leakage of the light transmissive medium.

19. The light collection and distribution system of claim 1, the liquid-filled light guide having an input end proximate the solar collector, further comprising means for cooling the input end.

20. The light collection and distribution system of claim 1, wherein the means for cooling the input end further comprises means for heating the structure with heat provided by the means for cooling.

21. The light collection and distribution system of claim 1, further comprising a plurality of liquid-filled light guides, each of the plurality of liquid-filled light guided having an input end coupled with a packing coupler.

22. The light collection and distribution system of claim 21, wherein the packing coupler contains a complementary plurality of light gathering elements arranged in a packed geometric pattern that reduces transmission losses of light between the packing coupler and the input ends as light impinges upon the packing coupler.

23. The light collection and distribution system of claim 22, wherein the light gathering elements comprise lenses.

24. A method of fitting a building with a light collection and distribution system, comprising:
installing a solar collector at a location capable of gathering sunlight;
installing a plurality of light dispersion devices; and
coupling the solar collector and the light dispersion devices with a liquid-filled light guide to establish a light transmissive pathway between the solar collector and the light dispersion devices.

25. A solar light distribution system, comprising:
a tubular structure having a first index of refraction and a diameter greater than one-half inch;
liquid material with favorable optical properties and having a second index of refraction; and
tubular end caps connectable to tubular structure that permits the transmission of light,
said liquid material contained within tubular structure by tubular end caps, such that light is permitted to traverse the assembly via total internal reflection,
said liquid material being transparent mineral oil with a specific gravity of 0.81 to 0.89,
said end caps connectable to other end caps and optical means to support the transmission of light.

26. A light collection and distribution system for use in illuminating the interior of a structure comprising:
a solar collector for use in gathering sunlight,
a light dispersion device capable of dispersing light collected by the solar collector for illumination purposes;
and a mineral oil-filled light guide connected to the solar collector, and the light dispersion device for transmission of light from the solar collector to the light dispersion device.

27. The light collection and distribution system of claim 1, the mineral oil filled light guide comprising a plurality of liquid filled light guide segments connected to one another by male-male interengagement.

28. The light collection and distribution system of claim 26, the light guide comprising junction formed by the first male in contact with a thin film of light transmissive medium and the second male end in contact with a thin film of light transmissive medium.

29. The light collection and distribution system of claim 1, wherein the solar collector incorporates an optical filter with a pass band in the visible spectrum.

30. The solar light distribution system of claim 25, wherein the tubular structure incorporates an optical filter with a pass band in the visible spectrum.
